(19) United States
(12) Patent Application Publication
(10) Pub. No.: US 2008/0035272 A1
(43) Pub. Date: Feb. 14, 2008

(54) DIRECT PRINTED LOOP FABRIC

(75) Inventors: Michael W. Mills, Cottage Grove, MN (US); Shou-Lu G. Wang, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/463,698

(22) Filed: Aug. 10, 2006

(51) Int. Cl. B32B 27/14; B32B 3/00; D03D 27/00; B32B 27/12

(52) U.S. Cl. 156/292; 428/92; 442/394; 428/167; 428/172; 428/195.1; 428/196; 428/198

(57) ABSTRACT

This invention relates to a loop fabric laminate bearing a graphic image and methods for printing such images on the back surface of the backing layer of the laminate. The loop fabric laminate is characterized by the presence of recessed and unrecessed areas in the backing layer, and the presence of ink deposited and retained in place in the recessed and unrecessed areas, with void defects of greater than 0.5 mm in largest dimension being present at a frequency of less than one void defect per square centimeter of printed area.

### FIELD OF THE INVENTION

The present invention relates to a low cost loop material for a hook and loop fastener. The invention further relates to methods for making and printing these loop materials.

### BACKGROUND OF THE INVENTION

Low cost loop fabrics are often made via lamination of nonwovens to backing layers. Such loop fabric laminates, as described in U.S. Pat. No. 5,616,394, U.S. Pat. No. 5,888,607, and US Published Application 2005/0136213 (all of which are incorporated by reference herein in their entirety), are often comprised of a sheet of nonwoven fibers having portions bonded or fused to a thermoplastic backing layer at spaced bonding regions, and arcuate portions projecting from a front surface of the backing layer between the bonding regions. Such loop fabric laminates are typically made by forming a sheet of fibers so that the sheet of fibers has arcuate portions projecting in the same direction from spaced anchor portions of the sheet of fibers, and then forming at least a portion of a backing layer around the spaced anchor portions of the sheet of fibers by extruding thermoplastic material onto the anchor portions of the sheet of fibers so that the arcuate portions of the sheet of fibers project from a front surface of the newly formed backing layer.

It is often desirable to have graphic images (pictures, shapes, colored areas, words, markings, bar codes, and the like) present on such loop fabric laminates. Thus, it would be desirable to print graphic images on the loop fabric laminate. The difficulties of printing on polyolefinic nonwovens are well known, therefore it is more expedient to provide the printed image on the back surface of the backing layer, rather than on the front (nonwoven) side of the laminate. Direct printing of the back surface of the backing layer has been proposed in for example U.S. Pat. No. 5,616,394. However, such back surface printing has proved problematic, as will be described herein. Accordingly, loop fabric laminates have typically been provided with graphics by providing a separate, preprinted, graphic-bearing film which is then laminated to the back surface of the backing layer. Such a process obviously is costly and complex, and can have deleterious effects such as rendering the fabric excessively rigid, as discussed in U.S. Pat. No. 5,888,607. Accordingly, a need exists for easily and inexpensively printing directly on the back surface of the backing layer of such loop fabric laminates.

### SUMMARY OF THE INVENTION

The present invention provides a loop fabric laminate material comprising a backing layer with front and back major surfaces, extending in at least a first direction, and a sheet of flexible nonwoven fabric intermittently bonded along the front major surface of the backing layer. Preferably, the loop has regularly spaced bond portions joining the nonwoven material and the backing layer. These intermittent bond anchor portions are separated by unbonded portions where the backing layer and the nonwoven material face each other, with the nonwoven material preferably projecting outward in an arcuate configuration. These loop composites further bear a graphic image on the back major surface of the backing layer, that is, on the side away from the nonwoven. The graphic image is substantially free of printing defects, as explained herein.

There is also provided a method for forming a nonwoven loop fabric laminate bearing a graphic image, which comprises (1) providing a first sheet of flexible nonwoven material (e.g., nonwoven web of natural and/or polymeric fibers, and/or yarns); (2) forming the first sheet of flexible nonwoven material to have arcuate portions projecting in the same direction from spaced anchor portions of the first sheet of flexible nonwoven material; (3) extruding a sheet of thermoplastic material onto the first sheet of flexible nonwoven material; (4) providing the film thermoplastic backing layer while still molten to at least the spaced anchor portions of the first sheet of flexible nonwoven material to bond the extruded thermoplastic film sheet to the nonwoven material at bond sites so as to form a loop fabric laminate with a backing layer; and (5) printing a graphic image onto the back surface of the backing layer. By this method there is provided a novel sheet-like nonwoven loop fabric laminate comprising a flexible nonwoven intermittently bonded to a backing layer bearing a graphic image.

In one embodiment, the method of the present invention comprises providing a loop fabric laminate comprising a backing layer of a nonporous thermoplastic polymeric film with front and back major surfaces, and a loop layer formed from a nonwoven web comprised of fibers formed from thermoplastic polymers, copolymers or blends, wherein the backing layer is bonded to the loop layer such that the loop layer has bonded regions and unbonded regions, the unbonded regions of the loop layer forming arcuate projections, and wherein the back major surface of the backing layer comprises relatively recessed areas underlain by the loop-layer arcuate projections, and comprises relatively unrecessed areas underlain by the bonded regions; and, transferring ink to the back major surface of the backing layer by means of flexographic printing comprising a screen value of about 40 percent to about 80 percent, a screen ruling of about 50 lpi to about 120 lpi, and an impression pressure applied to the loop fabric laminate, wherein the ink is transferred to and permanently retained in place on the recessed and unrecessed areas of the back major surface of the backing film.

In another embodiment, the method of the present invention comprises providing a loop fabric laminate comprising a backing layer of a nonporous thermoplastic polymeric film with front and back major surfaces, and a loop layer formed from a nonwoven web comprised of fibers formed from thermoplastic polymers, copolymers or blends, wherein the backing layer is bonded to the loop layer such that the loop layer has bonded regions and unbonded regions, the unbonded regions of the loop layer forming arcuate projections, and wherein the back major surface of the backing layer comprises relatively recessed areas underlain by the loop-layer arcuate projections, and comprises relatively unrecessed areas underlain by the bonded regions; and, transferring ink to the back major surface of the backing layer via contact printing, wherein the ink is transferred to and permanently retained in place on the recessed and unrecessed areas of the back major surface of the backing film, and wherein the graphic image comprises void defects of greater than 0.5 mm in largest dimension, at a frequency of less than one void defect per square centimeter of printed area.

In another embodiment, the present invention provides a loop fabric laminate comprising a backing layer of a nonporous thermoplastic polymeric film with front and back major surfaces and a loop layer formed from a nonwoven web comprised of fibers formed from thermoplastic polymers, copolymers or blends, wherein the backing layer is bonded to the loop layer such that the loop layer has bonded regions and unbonded regions, the unbonded regions of the loop layer forming arcuate projections, and wherein the back major surface of the backing layer comprises relatively recessed areas underlain by the loop-layer arcuate projections, and comprises relatively unrecessed areas underlain by the bonded regions; and, a graphic image comprising ink on the back surface of the backing layer, wherein the ink is present on the recessed and unrecessed areas of the back major surface of the backing layer, wherein the graphic image comprises void defects of greater than 0.5 mm in largest dimension, at a frequency of less than one void defect per square centimeter of printed area.

### BRIEF DESCRIPTION OF THE DRAWINGS

The present invention is further described in reference to accompanying drawings, where like reference numerals refer to like parts on several views, and wherein:

FIG. 1 is a perspective view of an embodiment of loop fabric laminate.

FIG. 2 is a schematic view illustrating a method of forming loop fabric laminate.

FIG. 3 is a perspective view of loop fabric laminate, as formed by the method of FIG. 2.

FIG. 4 is a scanning electron microphotograph of the back surface of the backing layer of a loop fabric laminate, as formed by the method of FIG. 2.

FIG. 5 is a schematic view illustrating a method of printing on loop material fabric laminate.

FIG. 6 is an optical photograph of an image printed at 30% screen value by the method depicted in FIG. 5.

FIG. 7 is an optical photograph of an image printed at 50% screen value by the method depicted in FIG. 5.

FIG. 8 is an optical photograph of an image printed at 70% screen value by the method depicted in FIG. 5.

FIG. 9 is an optical photograph of an image printed at 80% screen value by the method depicted in FIG. 5.

FIG. 10 is an optical photograph of an image printed at 90% screen value by the method depicted in FIG. 5.

FIG. 11 is an optical photograph of an image printed at 100% screen value by the method depicted in FIG. 5.

FIG. 12 is a 10× magnification optical photograph of an image printed at 50% screen value by the method depicted in FIG. 5.

FIG. 13 is a 10× magnification optical photograph of an image printed at 90% screen value by the method depicted in FIG. 5.

### DETAILED DESCRIPTION OF THE INVENTION

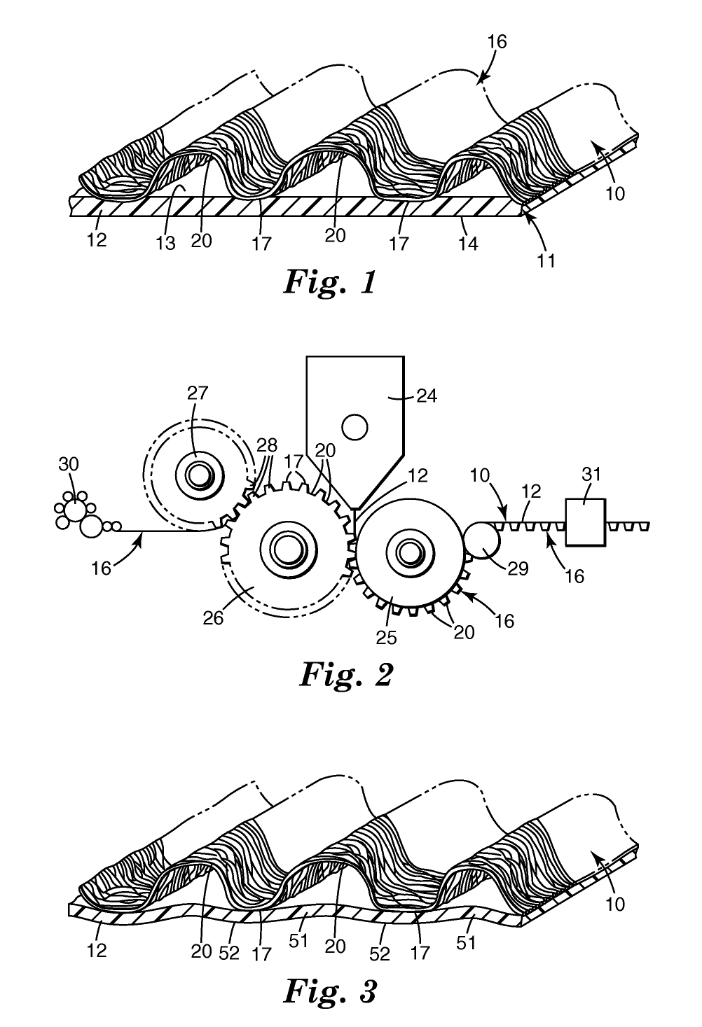

FIG. 1 illustrates a first embodiment of a sheet of loop material according to the present invention, generally designated by the reference numeral 10 which sheet of loop material 10 is adapted to be cut into pieces to form the loop portions for fasteners of the type intended for limited use garments and having releasably engagable hook and loop portions. Generally the sheet of loop material 10 has a backing 11 comprising a thermoplastic backing layer 12 (also referred to as the base layer, base film, or backing film) formed from, for example, polypropylene polymer or copolymer. The backing layer 12 is generally a film layer having a thickness in the range of about 0.00125 to 0.025 centimeters (0.0005 to 0.010 inch) and also preferably having generally uniform morphology, and front and rear major surfaces 13 and 14. A multiplicity of fibers in a formed sheet of nonwoven fibers 16 having generally non-deformed anchor portions 17 is autogenously bonded to the backing layer 12. The bonding regions 17 in FIG. 1 are along the front surface 13 with arcuate portions 20 of the sheet of fibers 16 projecting from the front surface 13 of the backing layer 12 between the bonding locations 17. As shown in FIG. 1 the bonding regions can be continuous rows extending transversely across the sheet of loop material 10. However the bonding regions can be arranged in any pattern including, for example, continuous rows extending down the sheet of loop material, intermittent lines, hexagonal cells, diamond cells, square cells, random point bonds, patterned point bonds, crosshatched lines, or any other regular or irregular geometric pattern.

The arcuate portions 20 of the sheet of fibers 16 between adjacent bonding locations have a generally uniform maximum height from the backing layer 12 of less than about 0.64 centimeters (0.250 inch) and preferably less than about 0.381 centimeters (0.150 inch). The height of the arcuate portions 20 of the formed sheet of fibers 16 (preferably a nonwoven web) is at least one third, and preferably one half to one and one half times the distance between adjacent bonding locations 17. The loop material without the backing layer 12 has a basis weight in the range of 5 to 300 grams per square meter (and preferably in the range of 15 to 100 grams per square meter) measured along the first surface 13. The fibers in the sheet of fibers should have sufficient space between them so that the open area between the fibers in the sheet of fibers 16 along the arcuate portions 20 (i.e., between about 10 and 90 percent open area) afford ready penetration and engagement of the hook fiber engaging portion of a hook fastener element. Generally, this requires that the sheet of fibers is nonconsolidated or the fibers in whole or in part are not bonded at the points where the individual fibers cross.

FIG. 2 schematically illustrates a method and equipment for forming the sheet of loop material 10 shown in FIG. 1. The method illustrated in FIG. 2 generally comprises forming a sheet of fibers using a nonwoven fiber web 16 so that it has arcuate portions 20 projecting in the same direction from spaced generally parallel anchor portions 17 of the nonwoven web 16, and bonding the spaced generally parallel anchor portions 17 of the nonwoven web 16 to the backing layer 12. This is performed in the FIG. 2 method by providing first and second corrugating members or rollers, 26 and 27 each having an axis and including a plurality of circumferentially spaced generally axially extending ridges 28 around and defining its periphery, with spaces between the ridges 28 adapted to receive portions of the ridges 28 of the other corrugating member, 26 or 27, in meshing relationship with the nonwoven web or sheet of fiber 16 between the meshed ridges 28. The corrugating members 26 and 27 are mounted in axially parallel relationship with portions of the ridges 28 meshing generally in the manner of gear teeth; at least one of the corrugating members, 26 or 27, is rotated; and the nonwoven web or other type of sheet of fibers 16 is fed between the meshed portions of the ridges 28 of the corrugating members 26 and 27 to generally corrugate the sheet of fibers 16. The corrugated nonwoven web or other sheet of fibers 16 is retained along the periphery of the first corrugating member 26 after it has moved past the meshed portions of the ridges 28. In the FIG. 2 method a thermoplastic backing layer 12 is formed and bonded to the anchor portions 17 of the sheet of fibers 16 on the end surfaces of the ridges 28 on the first corrugating member 26 by extruding or coextruding the thermoplastic polymeric backing layer 12 in a molten state from a die 24 into a nip between the anchor portions 17 of the sheet of fibers 16 on the periphery of the first corrugating member 26 and a cooling roll 25. This embeds the fibers of the nonwoven web or other sheet of fibers in the backing layer. After cooling by the cooling roll 25 in the nip the sheet of loop material 10 is separated from the first corrugating member 26 and carried partially around the cooling roll 25 and through a cooled nip between the cooled roller 25 and a pinch roller 29 to complete cooling and solidification of the backing layer 12.

An alternative to extruding a film 12 is supplying a preformed backing layer, for example, in the form of a backing film, into the nip formed between the first corrugating member 26 and a cooled nip roll 25. The ridges on the corrugating member 26 and/or the roll 25 are heated so as to thermally bond the film backing to the sheet of nonwoven fibers. In this case, an autogenous bond is not formed and the film backing layer is not of a uniform morphology.

The sheet of fibers is preferably in the form of a nonwoven web product such as can be formed from loose discrete fibers using a carding machine 30, which nonwoven web of randomly oriented fibers 16 has enough integrity to be fed from the, e.g., carding machine 30 into the nip between the corrugating members 26 and 27 (if needed, a conveyer (not shown) could be provided to help support and guide the nonwoven web 16 between the carding machine 30 and the corrugating members 26 and 27). When such a nonwoven web 16 is used, preferably the first corrugating member 26 has a rough finish (e.g., formed by sand blasting), the second corrugating member 27 has a smooth polished finish, and the first corrugating member 26 is heated to a temperature slightly above the temperature of the second corrugating member 26 so that the nonwoven web 16 will preferentially stay along the surface of the first corrugating member 26 and be carried to the nip between the first corrugating member and the roller 25 after passing through the nip between the corrugating members 26 and 27.

Corrugating members 26 and 27, as shown in FIG. 2, adapted to have a sheet of fibers 16 fed into them can have ridges 28 oriented generally in the range of 0 to 45 degrees with respect to its axes, but preferably have its ridges 28 oriented at 0 degrees with respect to (or parallel to) its axes which simplifies making of the corrugating members 26 and 27.

The cooled nip roll 25 in the embodiment shown in FIG. 2, using an extruded film backing, can be water cooled and have a chrome plated periphery. Alternatively, the cooled nip roll 25 may have an outer rubber layer defining its surface. If nip roll 25 is a heated roll (as for use with a preformed backing layer as described above) this could be by means of an oil or water heated roll or an induction roll.

Preferably for an extrusion bonded or thermally bonded method using corrugating rolls 26 and 27 and a nip roll 25, the drives for the corrugating members 26 and 27 and for the roller 25 can be rotated at a surface speed that is the same as or different than, the surface speed of the first corrugating member 26. When the nip roller 25 and the first corrugating member 26 are rotated so that they have the same surface speed, the sheet of fibers 16 will have about the same shape along the backing 11 as it had along the periphery of the first corrugating member 26. When the nip roll 25 and the first corrugating member 26 are rotated so that the nip roll 25 has a surface speed that is slower than the surface speed of the first corrugating member 26, (e.g., one quarter or one half) the anchor portions 17 of the sheet of fibers 16 will be moved closer together in the backing layer 12 at the nip between the nip roll 25 and the first corrugating member 26, resulting in greater density of the loop portions 20 along the backing 11 than when the cooled nip roll 25 and the first corrugating member 26 are rotated so that they have the same surface speed.

After the formation of the loop fabric laminate material, the laminate may be passed through printing station 31 of FIG. 2, such that the back surface of the backing layer is printed in-line. Alternatively, the laminate may be stored, for example, as a roll or jumbo, and printed later in a secondary operation.

The backing layer 12 preferably is a polyolefinic material such as polypropylene homopolymer or copolymer. The backing layer 12 can contain other components such as other thermoplastic polymers, dyes, pigments, or melt additives provided that these additional components do not adversely affect the bonding of the backing layer 12 to the fibrous loop layer. The backing layer 12 is typically nonporous. The backing layer 12 can be a largely inelastic material, a somewhat elastic material, or a substantially elastic material, according to the particular application. (In this context, “elastic” denotes a reversibly extensible material). Additionally, the backing layer 12 can be an irreversibly extensible and/or an orientable material of the type described US Published Application 2005/0136213. In such a case, the material may be printed before or after extension and/or orientation, as desired. The backing layer 12 can also be a coextruded film where at least the layer in contact with the sheet of fibers has a composition that allows satisfactory bonding to the fibrous loop layer. For example, a coextruded film layer 12 could comprise one or more polyethylene layers with intervening layers of polyethylene/polypropylene blends. Other tie layers and layer combinations are possible with use of the at least one bonding layer as described above.

The sheet of fibers 16 preferably is a nonwoven fibrous web material provided by carding as described above; however, other suitable methods for forming a fibrous nonwoven web can be used to form a nonwoven fibrous web loop layer, such as Rando webs, airlaid webs, spun-lace webs, spun-bond webs, or the like. Generally, a fibrous loop material using the above described nonwoven webs is preferably not prebonded or consolidated to maximum the open area between the fibers. However, in order to allow preformed webs to be handled, it is necessary on occasion to provide suitable point bonding and the like which should preferably be at a level only sufficient to provide integrity to unwind the preformed web from a roll and into the forming process for creating the invention nonwoven fibrous loop material.

Generally, the nonbonded portions of the sheet of fibers is from 65 to 95 percent providing bonding areas over from 5 to 35 percent of the cross sectional area the sheet of fibers, preferably the overall bonded area of the sheet of fibers is from 15 to 25 percent. The bonded regions include those areas of the sheet of fibers bonded to the backing layer as well as any prebonded or consolidated areas provided to improve web integrity. The specific bonding portions or areas bonded to the backing layer generally can be any width; however, preferably are from 0.1 to 0.2 centimeters in its narrowest width dimension. Adjacent bonding portions are generally on average spaced from 0.1 to 2.0 cm, and preferably 0.2 to 1.0 cm, apart. When the bonded portions are in the form of point bonds, the points are generally of substantially circular shape providing circular bonds preferably formed either by extrusion bonding or thermal bonding. Other shapes in the bonded and unbonded portions are possible, providing unbonded mounds or arcuate portions which are circular, triangular, hexagonal, or irregular in shape.

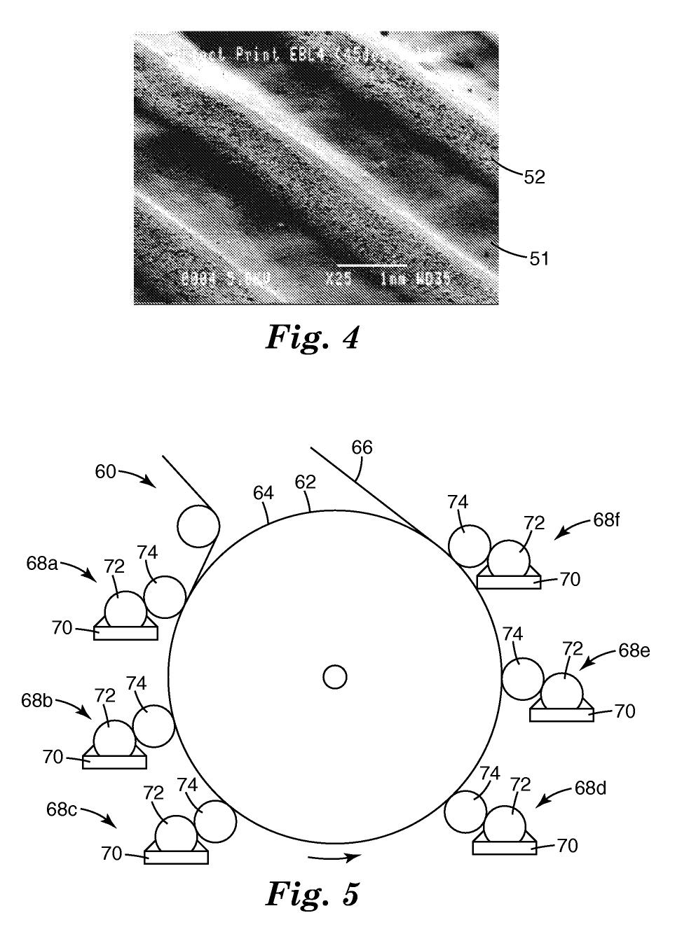

As discussed herein, it is desirable to print a graphic image on the back surface of the backing layer of a loop fabric laminate as described above, for example by passing it through printing station 31 of FIG. 2. However, difficulties are encountered in performing such printing, due to the unique structure of these loop fabric laminates. The backing layer of a loop fabric laminate of this type (for example, the product available from 3M Company, St. Paul Minn., under the designation EBL Light KN5059), typically exhibits a residual topography imparted by the manufacturing process. This topography is shown conceptually in FIG. 3. Rather than being uniformly flat as depicted in FIG. 1, the backing layer (when viewed from the back/printed side) typically exhibits a characteristic undulating topography comprising slightly recessed regions, and unrecessed regions. That is, area 51 of the backing layer underlying the middle portion 20 of the loop-layer arcuate projections (i.e., in between the bonding areas), projects slightly toward the fibers, causing the back surface of the backing layer in area 51 to be recessed relative to the back surface of adjacent area 52, which underlies the bonding region. This is further illustrated in FIG. 4, which is a 25× magnification scanning electron microscope image of the back surface of the backing layer of a typical loop fabric laminate described above. Recessed areas 51 underlie arcuate-projecting fiber areas 20 of the nonwoven. Unrecessed areas 52 underlie the bonding regions 17 where the nonwoven was bonded to the backing layer.

It has been found to be quite difficult to achieve satisfactory printing on the back surface of the backing layer of these loop fabric laminates. Specifically, when performing contact printing, e.g. flexographic printing, gross macroscopic void defects can occur unless the methods of the present invention are utilized. While not being limited by theory or mechanism, the residual topography of the backing layer may be such, in combination with the nonporous nature of the backing layer surface, the variable thickness of the underlying nonwoven, and the variable compressibility of the underlying nonwoven (the arcuate-projecting portions being quite compressible, and the melt-bonded/densified portions being substantially incompressible), that the fidelity of the ink-transfer process from the printing plate surface to the backing layer is compromised under normal printing conditions. Alternatively, it may be that the ink is transferred successfully, but for some reason the ink fails to stay on the backing layer surface in the location in which it is deposited.

FIG. 5 schematically illustrates a flexographic printing apparatus which may be used in the present invention. The printing apparatus may be utilized in-line, i.e., as in printing station 31 of FIG. 2, or off-line. The flexographic printing apparatus, generally indicated at 60, comprises a central rotary impression cylinder 62 having a circumferential outer surface 64 on which a continuous loop fabric substrate 66 (e.g., constructed in the manner of the loop fabric laminate 10 of FIG. 3) is transported by the impression cylinder in the direction of rotation thereof as indicated by the directional arrow in FIG. 5. Loop fabric laminate 66 is positioned such that the backing layer is facing away (e.g., outward) from the impression cylinder 62 outer surface. One or more print stations (six are shown in FIG. 5 and indicated generally at 68a, 68b, 68c, 68d, 68e and 68f) are positioned about the impression cylinder 62 in opposed relationship with the circumferential outer surface 64 of the impression cylinder 62. Each print station 68a, 68b, 68c, 68 d, 68e and 68f comprises an ink composition delivery and metering chambered doctor blade 70, and anilox (or metering) roll 72 rotatable into contact with the doctor blade 70 so that discrete cells in the outer surface of the anilox roll become filled with a predetermined volume of ink composition, and a print cylinder 74 carrying a raised rubber or photopolymer printing plate (not shown) corresponding to the desired graphic. The print cylinders 74 are rotatable to rotate the printing plate into contact with the anilox roll 72, whereby ink composition from the anilox roll is transferred to the printing plate. Further rotation of the print cylinder 74 rotates the inked printing plate into contact with the loop fabric laminate 66 so that the substrate becomes disposed within a nip formed between the printing plate and the impression cylinder 62.

The print stations 68a, 68b, 68c, 68d, 68e, 68f are each moveable relative to the impression cylinder 62 to apply an impression pressure between each printing cylinder 74 and the impression cylinder 62 (and hence the loop fabric laminate 66). This impression pressure may be adjusted as described herein. The print stations 68a, 68b, 68c, 68d, 68e and 68f may contain ink compositions of different colors or ink types to be used in forming an entire graphic, or multiple graphics on the loop fabric laminate 66. Less than all of the print stations may be used, including the use of a single print station where a unitary color graphic is to be applied to the loop fabric laminate 66.

In addition to the flexographic printing apparatus described above (relying on a single, central impression cylinder), the present invention is also suitable for other well-known flexographic printing methods using for example in-line or stacked printers (in which there may be an individual impression cylinder for each printing station, for example).

After being passed through a printing station or stations as described above, the substrate is typically passed through a heating station, e.g. an oven, so as to fix the deposited ink permanently in place. This may occur via removal of volatile components (i.e., removal of water or solvent), or via heat fixing or chemical crosslinking of binders in the ink. For proper printing fidelity, it is important that the ink be retained in place on the substrate, in the pattern imparted by the printing plate, before, during and after the drying or fixing operation.

General construction and operation of a flexographic printing apparatus is well known to those skilled in the art and will not be further described herein except to the extent necessary to describe the present invention. As an example, flexographic printing apparatus are shown and/or described in U.S. Pat. No. 5,458,590 (Schleinz et al.); U.S. Pat. No. 5,566,616 (Schleinz et al.); U.S. 2003/0019374A1 (Harte); and U.S. Pat. No. 4,896,600 (Rogge et al.). The flexographic printing apparatus can be configured for block printing, wherein the printing plate contains solid regions that are raised and are in the shape of the desired graphic so that a continuous or solid graphic is applied to the nonwoven substrate. In another embodiment, the printing plate is configured for line printing, which is known to those skilled in the art. Alternatively, the flexographic printing apparatus may be configured for dot process printing or stochastic printing.

In particular, suitable flexographic printing methods of the present invention include so-called spot color printing (in which one or more particular inks are printed), as well as so-called process color or halftone printing, in which patterns of different colors (such as Cyan, Magenta, Yellow, and Black) are printed separately (such as by use of the multiple printing stations 68a, 68b, etc., described above) so as to achieve a composite image or images when viewed. Combinations of spot color and halftone printing may also be used. Regardless of the specific method chosen, the printing process relies on the transfer of ink from raised elements on the printing plate surface to the substrate to be printed. The raised elements can comprise individual, discrete elements, thus resulting in the formation of individual, discrete areas (“dots”) of ink on the substrate. This type of printing is commonly referred to as “open dot” printing. Conversely, the printing plate can be designed such that the raised ink-transfer surface comprises a contiguous structure containing discrete voids (so called “reverse dot” or “closed dot” printing). In this case a pattern of deposited ink results which is a continuous pattern interrupted by ink-free voids. Circular dots are often used, but a wide variety of other shapes, such as ellipses, squares, diamonds, etc. are also commonly used. Additionally, dots of identical size are often used, but dots of differing size may also be employed.

Important variables in the methods of the present invention are the spacing of the individual dots and the size of the individual dots. The spacing and size of the individual dots are dictated by the size and spacing of raised ink-transfer elements on the surface of the printing plate, as detailed above. Such elements can be designed and formed according to the standard methods used in flexographic printing.

The dot spacing is characterized by a parameter known as the screen ruling, in lines per inch (lpi) or lines per centimeter (lpc). The higher the screen ruling the smaller the dot size that can be used, the smoother the image will appear, and the more detail that can be resolved.

The other parameter of importance is the dot size. In flexographic printing, this is characterized by a parameter known as the screen value (also referred to as screen density or percent screen). A screen value of 0% indicates no ink deposited at all, whereas a screen value of 100% indicates total coverage of the substrate with ink. In between these extremes, the screen value is set such that the dot size and percentage ink coverage of the substrate by that particular color ink are appropriate for the image to be displayed and the desired visual effect. The screen value nominally corresponds to the percent coverage of the substrate by the printing ink; in practice, depending on such printing conditions as the pressure applied, the durometer of the printing plate, etc., the ink may spread thus resulting in an ink coverage somewhat greater than the nominal screen value.

Regardless of whether open or closed dot printing is used, as the screen value is increased, the area occupied by the raised ink-transfer elements of the printing plate will increase, and the edges of adjacent ink-transfer elements will approach each other as the dimension of the void separating them is decreased.

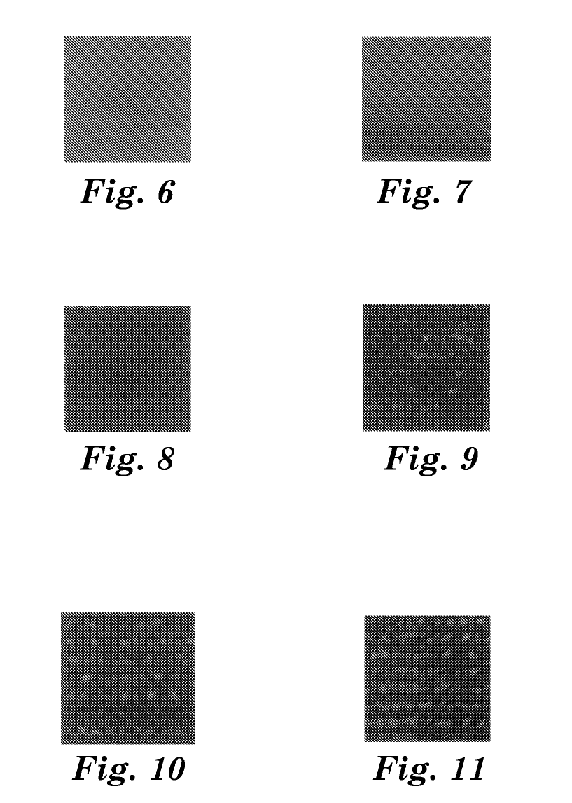

The screen value (and the screen ruling, which as explained above is a separately controllable parameter) is ordinarily chosen based on the vibrancy of the image desired, the level of detail of detail to be shown, and the like. That is, the fidelity of the printing process is usually satisfactory over a wide range of screen values, within which the user simply selects the appropriate value based on the desired visual effect. However, the methods of the present invention are based on the discovery that, when printing the back surface of a loop fabric laminate backing layer, the screen value can have a significant impact on the printing process, specifically on the fidelity of the process in which the ink is transferred to and retained in place on the surface of the backing layer. The effect of screen value is shown in FIGS. 6-11, which are images of a typical loop fabric laminate which had been printed on the back surface of the backing layer using flexographic halftone printing methods described herein. The printed images are squares of red/blue halftone images (although reproduced herein in grey scale) printed at various screen values as denoted (with screen ruling and impression pressure held constant). The printed images were approximately 20 mm square and are reproduced herein at close to their actual size.

At extremely low screen values the image is fainter and less visible. For the present loop fabric laminate, the image is typically viewed (by the end user of the product) through the nonwoven layer and the backing layer, so it is preferable to avoid screen values of less than about 40 percent, so as to make the graphic image as bright or vibrant as possible when viewed in this manner. In general, therefore, it is preferred to use high screen values. Surprisingly, however, very high screen values result in gross printing defects resulting in a poor image. This is manifested in macroscopic void defects clearly visible to the naked eye. Such void defects are exhibited, for example, in FIGS. 9, 10 and 11, (at 80, 90 and 100% screen value, respectively).

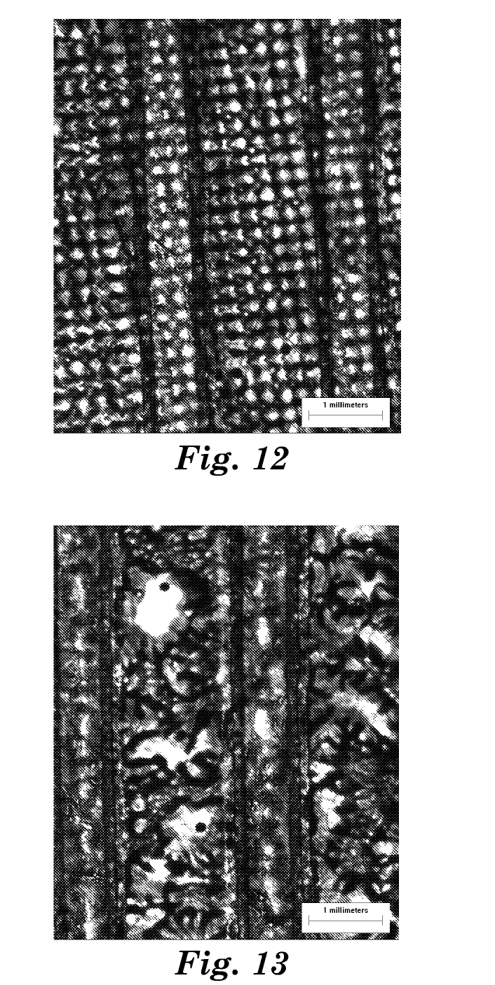

This phenomena is further detailed in FIGS. 12 and 13, which are 10× magnification optical photographs of images printed in black ink on the back surface of the backing layer of a typical loop fabric laminate using flexographic printing methods described herein. FIG. 12. depicts a sample printed at 50% screen value. The halftone dot printing pattern is clearly evident. FIG. 13 depicts a sample printed at 90% screen value. In this case, the printed area comprises a chaotic pattern of void defects completely lacking ink, and adjacent areas with excess amounts of ink.

Upon examination of FIGS. 6-11, a clear trend is found. As the screen value is increased, the amount of ink is greater thus the optical density, brightness, vibrancy, etc., of the image is increased. However, as the screen value is increased, gross macroscopic ink-free void defects are present which may be in the range of 0.25, 0.5, and even up to 1.0 mm in dimension, and which may render the image somewhat or completely unacceptable. Typically, for the loop fabric laminate of the present invention, an image printed at about 70% screen value or less is most preferable, for naked eye viewing. An image printed at up to about 80% screen value may be acceptable depending on the particular image, color, expected viewing conditions and so on. Typically, at screen values of over about 80%, the void defects are completely prohibitive.

Thus, in the present invention it has been found that the lower limit of acceptable screen value is governed by the fact that the printed image is typically viewed through the thickness of both the backing layer and the nonwoven. Accordingly, via the methods of the present invention, a lower limit of screen value of about 40% is preferable, and a lower limit of about 50% is more preferable. The upper limit of acceptable screen value is governed by the fidelity of the printing process and in particular by the onset of macroscopic void defects. Accordingly, an upper limit of about 80% is preferable, and an upper limit of 70% is more preferable.

Examination of the printed loop fabric laminate reveals that as the screen value is increased, void defects tend to show up first, and most often, in the recessed areas 51 (as evidenced in FIG. 10, for example). A feature of the current invention is thus that the printed loop fabric laminate possesses ink successfully deposited and retained in place in the recessed areas 51 that are underlain by arcuate-projecting nonwoven areas 20, as well as in the unrecessed areas 52 that are underlain by substantially bonded areas 17. That is, the product of the present invention is characterized as having ink present, in a substantially defect-free condition, in both the recessed and unrecessed areas. In this context, substantially defect-free means that the viewed graphic image presents a substantially continuous structure with preferably fewer than one void defect of greater than 0.5 mm, in largest dimension, being present per square cm of printed area. This corresponds to a satisfactory image when viewed with the naked eye from a distance of approximately eight inches. More preferably, the graphic image comprises fewer than one such void defect per two square cm of printed area. In this context, a “void defect” is an area of the substrate that is missing ink, said area which would have been expected to possess ink based on the printing plate pattern. That is, such void defects are to be differentiated from the ink-free areas that occur naturally in the printing process (i.e. voids corresponding to the pattern established by the ink-transfer surface of the printing plate). It should also be noted that in e.g. multiple color printing, a “void defect” may still comprise ink. For example, a “void defect” may be present resulting from a black-ink printing process, even though the defect area may contain yellow ink deposited in the yellow-ink printing process. Such an area still comprises a visible printing defect and constitutes a void defect as defined herein.

The product of the present invention is further characterized by the presence of ink covering preferably at least about 40% of the printed area of the back surface of the backing layer, more preferably at least about 50% of the printed area, while void defects of greater than 0.5 mm in largest dimension are present at less than one per square cm of printed area. (In this context, the term ink denotes an ink of a particular color, and multiple inks may be present in the same printed area). Restated, the only voids that are present at greater than one per square cm are those small-scale voids corresponding to the pattern established by the ink-transfer surface of the printing plate.

As mentioned previously, the dot spacing, as characterized by the screen ruling in lines per inch, is also of importance. Extremely high screen rulings have been found to impart void defects, even if the most advantageous screen values are used. In the methods of the present invention, an upper limit of about 150 lpi is preferred, an upper limit of about 120 is more preferred, and an upper limit of about 100 lpi is most preferred. Low screen rulings may lead to an image that is too coarse or grainy. For the present application, a lower limit of about 50 lpi is preferred, a lower limit of about 60 lpi is more preferred, and a lower limit of about 80 lpi is most preferred.

A printed image for the purposes of the present invention is defined to comprise a printed area of at least about 1.0 mm in at least two dimensions, thus an image in the context of the present invention comprises a plurality of dots (whether printed in open or closed dot configuration). Typically, such an image is comprised of hundreds of individual dots. Even if block printing, line printing or spot-color printing is performed (for example, if monocolor or two-color graphic elements are printed), it still may be necessary to use a printing plate surface comprising discrete small-scale elements (“dots”, whether open or closed), with printing parameters selected from those presented above, to achieve sufficiently defect-free printing. This may not be needed, however, if the graphic element to be printed is sufficiently small in at least one lateral dimension, for example in the printing of stroke, accent or border lines. In this circumstance the ink-transfer element may be of sufficiently small size and/or separated from other elements, such that the aforementioned void defects do not occur; or, the presence of such defects is not readily apparent because of the small size of the image.

In flexographic printing, the ink is transferred to the backing film of the loop fabric laminate with the laminate under an impression pressure exerted between the printing cylinder and the impression cylinder. The impression pressure used in the printing process is an important variable in achieving a satisfactory graphic image. It should be noted that it may be difficult to apply specific numerical values to the impression pressure used in printing equipment. In fact, many printing lines may not be equipped to provide quantitative measures (whether a dimensional set point, a transducer-derived pressure, or other) of impression pressure. However, it has been found that in the methods of the present invention, it is preferable to use an elevated printing pressure. In this context, an elevated impression pressure denotes that the printing apparatus is configured so as to apply more pressure than is customarily used on the same equipment for printing a flat and/or substantially incompressible substrate, such as plastic film, paper, foil, and the like. An elevated impression pressure is thus defined in relation to the specific printing apparatus used, and denotes a printing pressure, whether measured quantitatively or not, which is higher than that which is customarily used on the same printing line for printing flat, incompressible substrates. One way to define the impression pressure of the print plate against an impression cylinder is by means of a dimensional set point relative to a zero position setting in which the printing plate touches the impression cylinder with zero pressure therebetween. A positive set point means movement of the print plate further inward against the impression cylinder so as to apply a pressure thereto. If such an impression set point is obtainable, a preferable range for the impression set point is from 0.175 mm greater to 1.5 mm greater than the set point customarily used on the same printing line for printing flat, incompressible substrates.

The material used as the ink transfer media (i.e., the printing plate) may be chosen according to its thickness, durometer, and other properties, as is common in the art of printing. Likewise, the type of printing ink selected (e.g. water based, solvent based, or UV-curable), and the printing ink properties (viscosity, surface tension, etc.), may be selected according to techniques known in the art. In particular, the dictates of printing on the backing layer, which is typically a low surface energy polyolefinic material (e.g. polypropylene), may determine the choice of ink to be utilized. In addition, the surface of the backing layer may be treated so as to increase its surface energy, by any of the well-established methods such as corona treatment. Ideally such treatment should raise the surface energy of the substrate to at least about 35 dynes per cm for solvent based inks and at least about 40 dynes per cm for water based inks.

The anilox rolls may be provided with cell counts that are most compatible with the screen ruling. A common standard in the art is to use a cell count that is around four times the value of the screen ruling. For example, for an 85 lpi screen ruling, an anilox roll with a cell count of 200-340 lpi may be ideal.

### EXAMPLES

### Example 1

A loop fabric laminate of the type described above (available from 3M Company, St. Paul, Minn., under the designation EBL Light KN5059) was printed using the following procedure. An eight-color central impression flexographic printing apparatus (manufactured by WindMoller and Holscher) was utilized. The printing apparatus was configured to print an ornamental image via a combination of spot color and process color (halftone) printing. Two process color water-based inks were used (black and yellow), available from Press Color, and four spot-color water-based inks (Pantone 032 red, 2995 blue, 375 green and 151 orange), available from Press Color. The inks were prepared at target pH of 9.3-9.5, and target viscosity of 32 seconds, using a standard Zahn #2 Viscosity Cup method. Each printing cylinder of the printing apparatus was equipped with a printing plate available under the tradename CYREL DPI 67 from DuPont, Wilmington, Del. The thickness of each printing plate was 1.675 mm and the durometer was 69 (Shore A). The printing plates were mounted onto the printing cylinders with Eclipse 2000 stickyback tape available from Edward Graphics. The printing plates all had a screen ruling of 85 lpi, and a screen value of 65 percent. Anilox rolls of 250-360 lpi were used. The printing plates were configured relative to the impression cylinder with an impression set point of 0.425-0.50 mm (versus the impression set point of 0.25 mm typically used in printing flat films on this particular printing line).

An in-line corona treater (operating at a nominal power of 12 kW) was used to corona treat the back surface of the backing layer, immediately prior to the backing layer being printed.

A forced air oven (operating at a temperature of 63 degrees C.) was used to dry the ink immediately after the loop fabric laminate was printed.

The loop fabric laminate was printed at a line speed of 152 meters per minute.

Excellent results were obtained via the above printing method, resulting in a very acceptable image when viewed with the naked eye.

### Example 2

A loop fabric laminate of the type described above (available from 3M Company, St. Paul, Minn., under the designation EBL Light KN5059) was printed using the following procedure. An eight-color central impression flexographic printing apparatus (manufactured by WindMoller and Holscher) was utilized. The printing apparatus was configured to print an ornamental image via a combination of spot color and process color (halftone) printing using a closed dot pattern. One process color ink was used (Aqua Surf Black available from Sun Chemical), and one spot color (300. Blue available from Press Color). The inks were prepared at target pH of 9.3-9.5, and target viscosity of 32 seconds, using a standard Zahn #2 Viscosity Cup method. Each printing cylinder was equipped with a Digital Image Solvent Process printing plate available under the tradename CYREL DPI 67 from DuPont, Wilmington, Del. The thickness of each printing plate was 1.67 mm and the durometer was 69 (Shore A). The circumference of each plate was 61 cm. The printing plates were mounted onto the printing cylinders with Eclipse 2000 stickyback tape available from Edward Graphics. Each printing plate had a screen ruling of 100 lpi. A screen value of 70 percent was used for the blue spot color ink and a screen value of 100 percent was used for the black process color ink. A 360 lpi anilox roll was used for the blue ink and a 300 lpi anilox roll was used for the black. The printing cylinders were configured such that the impression set point for the black ink was at the standard nominal value used for printing flat films, whereas the impression set point for the blue was set at 0.25 mm over the standard flat film set point. The exact value of set point was not recorded.

An in-line corona treater (operating at a nominal power of 7 kW) was used to corona treat the back surface of the backing layer, immediately prior to the loop fabric laminate being printed.

A forced air oven (operating at a temperature of 63 degrees C.) was used to dry the ink immediately after the loop fabric laminate was printed.

The loop fabric laminate was printed at a line speed of 213 meters per minute.

Excellent results were obtained via the above printing method for the blue-ink printed areas, resulting in a highly acceptable image when viewed with the naked eye. In this example, the black-ink areas (printed at 100 percent screen value), were only printed as very thin outlines surrounding the blue areas. Typical line thickness was about 0.35 mm. Therefore, even though the black ink areas were printed at a nominal 100% screen value, the width of the printing plate element used to print the black ink lines was so small that the void defect problem either did not arise or was not perceptible in naked-eye viewing.

### Example 3

A loop fabric laminate of the type described above (available from 3M Company, St. Paul, Minn., under the designation EBL Light KN5059) was printed using the following procedure. An eight-color central impression flexographic printing apparatus (manufactured by Paper Converting) was utilized. The printing apparatus was configured to print an ornamental pattern via a combination of spot color and process color (halftone) printing. Four process color inks were used (C,M,Y,K, solvent based inks available under the tradename Flexomax from Sun Chemical, Parsippany, N.J.), and two spot color inks were used (Pantone 151 orange and Pantone 3272 green solvent based inks available under the tradename Flexomax from Sun Chemical, Parsippany, N.J.). The inks were prepared at target viscosity of 40-105 seconds, using a standard Zahn #2 Viscosity Cup method. The printing cylinders were equipped with printing plates of 60-65 durometer available under the tradename CYREL from DuPont, Wilmington, Del. The printing plates were made by a Cyrel Fast 1000 TD plate processor, available from Dupont, Wilmington, Del. The thickness of the printing plate and method of mounting onto the printing cylinder were not recorded. The printing plates all had a screen ruling of 100 lpi and a screen value of 70 percent. The lpi of the anilox rolls was not recorded. The printing cylinders were configured such that the impression set points for both ink-printing stations were 1.5 mm greater than the standard smooth film impression pressure typically used in that printing line. The exact value of set point was not recorded.

An in-line corona treater was used to corona treat the back surface of the backing layer, immediately prior to the loop fabric laminate being printed such that the surface of the backing film was brought to a surface tension estimated to be about 35 dynes per centimeter.

A forced air oven was used to dry the ink immediately after the loop fabric laminate was printed.

The loop fabric laminate was printed at a line speed of 122 meters per minute with excellent results.

1. A method of manufacturing a loop fabric laminate bearing a graphic image, comprising:
providing a loop fabric laminate comprising:
a backing layer comprising a nonporous thermoplastic polymeric film with front and back major surfaces,
a loop layer formed from a nonwoven web comprised of fibers formed from thermoplastic polymers, copolymers, or blends,
wherein the backing layer is bonded to the loop layer such that the loop layer has bonded regions and unbonded regions, the unbonded regions of the loop layer forming arcuate projections,
and wherein the back major surface of the backing layer comprises relatively recessed areas underlain by the loop-layer arcuate projections, and
comprises relatively unrecessed areas underlain by the bonded regions, and, transferring ink to the back major surface of the backing layer by means of flexographic printing comprising a screen value of about 40 percent to about 80 percent, a screen ruling of about 50 lpi to about 150 lpi, and an impression pressure applied to the loop fabric laminate,
wherein the ink is transferred to and permanently retained in place on the recessed and unrecessed areas of the back major surface of the backing film.

2. A method according to claim 1 wherein the flexographic printing process comprises a screen value of about 50 percent to about 70 percent.

3. A method according to claim 1 wherein the flexographic printing process comprises a screen ruling of about 60 lpi to about 120 lpi.

4. A method according to claim 1 wherein the flexographic printing comprises an elevated impression pressure.

5. A method according to claim 1 wherein the flexographic printing process comprises treating the back major surface so as to increase the surface energy to greater than about 35 dynes.

6. A method according to claim 5 wherein the treatment of the back major surface comprises corona treatment.

7. A method of manufacturing a loop fabric laminate bearing a graphic image, comprising:
providing a loop fabric laminate comprising:
a backing layer comprising a nonporous thermoplastic polymeric film with front and back major surfaces,
a loop layer formed from a nonwoven web comprised of fibers formed from thermoplastic polymers, copolymers, or blends,
wherein the backing layer is bonded to the loop layer such that the loop layer has bonded regions and unbonded regions, the unbonded regions of the loop layer forming arcuate projections,
and wherein the back major surface of the backing layer comprises relatively recessed areas underlain by the loop-layer arcuate projections, and
comprises relatively unrecessed areas underlain by the bonded regions, and, transferring ink via contact printing to the back major surface of the backing film;
wherein the ink is transferred to and permanently retained in place on the recessed and unrecessed areas of the back major surface of the backing film,
and wherein the graphic image comprises void defects of greater than 0.5 mm in largest dimension, at a frequency of less than one void defect per square centimeter of printed area.

8. A method according to claim 7, wherein the ink transfer contact printing process comprises flexographic printing.

9. A method according to claim 8, wherein the flexographic printing process comprises a screen value of about 40 percent to about 80 percent.

10. A method according to claim 8, wherein the flexographic printing process comprises a screen value of about 50 percent to about 70 percent.

11. A method according to claim 8, wherein the flexographic printing process comprises a screen ruling of about 50 lpi to about 150 lpi.

12. A method according to claim 8, wherein the flexographic printing process comprises a screen ruling of about 60 lpi to about 120 lpi.

13. A method according to claim 8, wherein the flexographic printing process comprises an elevated impression pressure.

14. A method according to claim 8, wherein the flexographic printing process comprises treating the back major surface so as to increase the surface energy to greater than about 35 dynes.

15. A method according to claim 14, wherein the treatment of the back major surface comprises corona treatment.

16. A loop fabric laminate bearing a graphic image, comprising:
a backing layer comprising a nonporous thermoplastic polymeric film with front and back major surfaces;
a loop layer formed from a nonwoven web comprised of fibers formed from thermoplastic polymers, copolymers, or blends;
wherein the backing layer is bonded to the loop layer such that the loop layer has bonded regions and unbonded regions, the unbonded regions of the loop layer forming arcuate projections,
and wherein the back major surface of the backing layer comprises relatively recessed areas underlain by the loop-layer arcuate projections, and
comprises relatively unrecessed areas underlain by the bonded regions;
a graphic image comprising an ink on the back major surface of the backing layer,
wherein the ink is present on the recessed and unrecessed areas of the back major surface of the backing film,
and, wherein the graphic image comprises void defects of greater than 0.5 mm in largest dimension, at a frequency of less than one void defect per square centimeter of printed area.

17. The article of claim 16 wherein the percent coverage of the substrate by the ink in the printed area is about 40 percent to about 80 percent.

18. The article of claim 16 wherein the percent coverage of the substrate by the ink in the printed area is about 50 percent to about 70 percent.
